(19) United States
(12) Patent Application Publication
(10) Pub. No.: US 2026/0027848 A1
(43) Pub. Date: Jan. 29, 2026

(54) CARD AND CARD USAGE APPARATUS

(71) Applicant: Katsuhiko KONDO, Tokyo (JP)

(72) Inventor: Katsuhiko KONDO, Tokyo (JP)

(21) Appl. No.: 19/344,028

(22) Filed: Sep. 29, 2025

Related U.S. Application Data
(63) Continuation of application No. PCT/JP2024/007738, filed on Mar. 1, 2024.

(30) Foreign Application Priority Data
Mar. 30, 2023 (JP) 2023-055966

(51) Int. Cl. B42D 25/305; B42D 25/378; G06K 19/077; G06Q 20/40

(52) U.S. Cl. CPC B42D 25/305; B42D 25/378; G06K 19/07707; G06Q 20/40145

(57) ABSTRACT

A card includes an invisible code section in which a biometric code obtained by encoding the biometric information of a user using a predetermined encoding process is recorded in an invisible manner, a memory that stores encrypted information encrypted using the biometric information, and a display section that displays reference information referenced by the user when using the card.

### CROSS REFERENCE TO RELATED APPLICATIONS

This application is a continuation of International Patent Application No. PCT/JP2024/007738, having an international filing date of Mar. 1, 2024, which designated the United States, the entirety of which is incorporated herein by reference. Japanese Patent Application No. 2023-055966 filed on Mar. 30, 2023 is also incorporated herein by reference in its entirety.

### BACKGROUND OF THE INVENTION

The present disclosure relates to cards and the like that users carry and use.

Information recording cards are known as cards that users carry and use, such as prepaid cards, cash cards, credit cards, ID cards, and membership cards. There are widely known information recording cards called “IC cards”, for example.

Some IC cards are equipped with a display for displaying information. For example, Japanese Unexamined Patent Application Publication No. 2005-293454 discloses a technique for manufacturing an IC card by which an electrophoretic display device (EPD) can be mounted on the IC card in a single pressure-bonding step.

Furthermore, some IC cards use biometric authentication to prevent unauthorized use by persons other than the registered user through “spoofing.” For example, Japanese Unexamined Patent Application Publication No. 2006-65455 discloses an IC card technology in which an IC card is equipped with a capacitance type fingerprint sensor and an EPD, and authentication is performed by comparing the fingerprint information acquired by the sensor with fingerprint authentication data stored in the IC chip.

### BRIEF DESCRIPTION OF THE DRAWINGS

FIG. 1 is a diagram illustrating a configuration example of a card usage system.

FIG. 2 is an external view of a card as seen from the front side.

FIG. 3 is an exploded perspective view of an example structure of the card, as seen from obliquely above the front surface of the card.

FIG. 4 is a flowchart illustrating a production process of the card.

FIG. 5 is a schematic vertical cross-sectional view of a configuration example of a card usage apparatus.

FIG. 6 is a diagram illustrating functional sections mounted on a controller board, and programs, data, etc. stored in an IC memory.

FIG. 7 is a flowchart illustrating a flow of processing in the card usage apparatus.

FIG. 8 is a diagram illustrating a modified example of the card.

FIG. 9 is a diagram illustrating a modified example of the card.

FIG. 10 is a diagram illustrating a modified example of the card.

FIG. 11A is a diagram illustrating a modified example of encryption process definition data.

FIG. 11B is a diagram illustrating a modified example of encryption process definition data.

FIG. 11C is a diagram illustrating a modified example of encryption process definition data.

### DETAILED DESCRIPTION

The following disclosure provides many different embodiments, or examples, for implementing different features of the provided subject matter. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Further, when a first element is described as being “connected” or “coupled” to a second element, such description includes embodiments in which the first and second elements are directly connected or coupled to each other, and also includes embodiments in which the first and second elements are indirectly connected or coupled to each other with one or more other intervening elements in between.

In accordance with a first aspect, there is provided a card carried and used by a user, comprising:
an invisible code section in which a biometric code obtained by encoding biometric information of the user through a predetermined encoding process is recorded in an invisible state;
a memory configured to store encrypted information encrypted using the biometric information; and
a display section configured to display reference information that is referenced by the user when using the card.

According to the first aspect, the biometric information is encoded and recorded on the card in an invisible manner. Therefore, it is possible to easily verify the identity of the user when using the card, while cleverly concealing biometric information, thereby improving the security of the card.

In accordance with a second aspect, there is provided the card, further comprising a transparent or translucent sheet layer provided on the display section, wherein the invisible code section may be provided on the sheet layer.

According to the second aspect, the card has an invisible code section provided on the sheet layer. Therefore, for example, an unused card with a sheet layer may be prepared before card issuance, and then issue the card by additionally forming the invisible code section on the sheet layer at the time of card issuance.

In accordance with a third aspect, there is provided the card, wherein
the biometric code recorded in the invisible code section may be fixedly recorded in a state that is capable of being photographed by a predetermined camera, and
the encrypted information may be information that is encrypted in a manner capable of being decrypted based on the biometric code photographed by the camera.

According to the third aspect, the encrypted information cannot be decrypted without the biometric information of the legitimate user who owns the card, which makes it possible to further improve the security of the card.

In accordance with a fourth aspect, there is provided the card, wherein
the encrypted information may be information that is used upon use of the card by the user, and
the display section may update and displays the reference information, which is to be updated in accordance with use of the encrypted information, every time the encrypted information is used.

According to the fourth aspect, the reference information is updated and displayed on the display section as the encrypted information is used, so that it is possible to achieve both convenience and improved security of the card.

In accordance with a fifth aspect, there is provided the card, wherein
the encrypted information may be information relating to electronic money, and
the memory may store information obtained by decrypting and using the encrypted information based on the biometric code, and encrypting the information after use based on the biometric code, as the new encrypted information.

According to the fifth aspect, it is possible to implement a card for using electronic money.

In accordance with a sixth aspect, the reference information may include at least information indicating a balance of the electronic money.

According to the sixth aspect, it is possible to achieve both convenience and security of the electronic money card.

In accordance with a seventh aspect, the display section may be electronic paper.

According to the seventh aspect, it is possible to maintain the reference information displayed on the display section in a displayed state.

In accordance with an eighth aspect, there is provided a card usage apparatus comprising:
a special reading section configured to photograph and read the biometric code from the card according to one of the above aspects;
a biometric information reading section configured to read biometric information from the user;
an authentication processing section configured to perform an authentication process based on the biometric information read by the biometric information reading section and the biometric code read by the special reading section;
a decryption processing section configured to, if authentication by the authentication process succeeds, decrypt the encrypted information stored in the memory using the biometric information read by the biometric information reading section;
an information usage processing section configured to, if decryption by the decryption processing section succeeds, execute a predetermined information usage process based on the decrypted information; and
an encrypted information update processing section configured to encrypt the information updated in the information usage process using the biometric information read by the biometric information reading section and store the encrypted information in the memory as the new encrypted information.

According to the eighth aspect, it is possible to implement an apparatus for using the card of the above aspect.

In accordance with a ninth aspect, there is provided a card usage apparatus comprising:
a special reading section configured to photograph and read the biometric code from the card according to one of the above aspects;
a biometric information reading section configured to read biometric information from the user;
an authentication processing section configured to perform an authentication process based on the biometric information read by the biometric information reading section and the biometric code read by the special reading section;
a decryption processing section configured to, if authentication by the authentication process succeeds, decrypt the encrypted information stored in the memory using the biometric information read by the biometric information reading section;
a settlement processing section configured to, if decryption by the decryption processing section succeeds, execute a predetermined settlement process based on the decrypted information;
an encrypted information update processing section configured to generate the new encrypted information by encrypting the information updated in the settlement process using the biometric information read by the biometric information reading section, and store the new encrypted information in the memory; and
a display update control section configured to cause the new reference information based on the information updated in the settlement process to be displayed on the display section.

According to the ninth aspect, it is possible to implement an apparatus that allows the card of the above aspect to be used for settlement.

In accordance with a tenth aspect, there is provided the card usage apparatus, wherein
the biometric information may include a plurality of types of biometric information,
the encrypted information may be encrypted with a type of biometric information selected in accordance with a predetermined selection logic based on the reference information,
the decryption processing section may decrypt the encrypted information stored in the memory using the type of biometric information selected in accordance with the selection logic based on the reference information before the settlement process, and
the encrypted information update processing section may generate the new encrypted information by encrypting the information updated in the settlement process using the type of biometric information selected in accordance with the selection logic based on the new reference information.

According to the tenth aspect, it is possible to implement a card usage apparatus with further improved card security.

Exemplary embodiments are described below. Note that the following exemplary embodiments do not in any way limit the scope of the content defined by the claims laid out herein. Note also that all of the elements described in the present embodiment should not necessarily be taken as essential elements.

Hereinafter, an example of the present embodiment will be described. However, it is clear that the mode to which the present invention is applicable is not limited to the following embodiment.

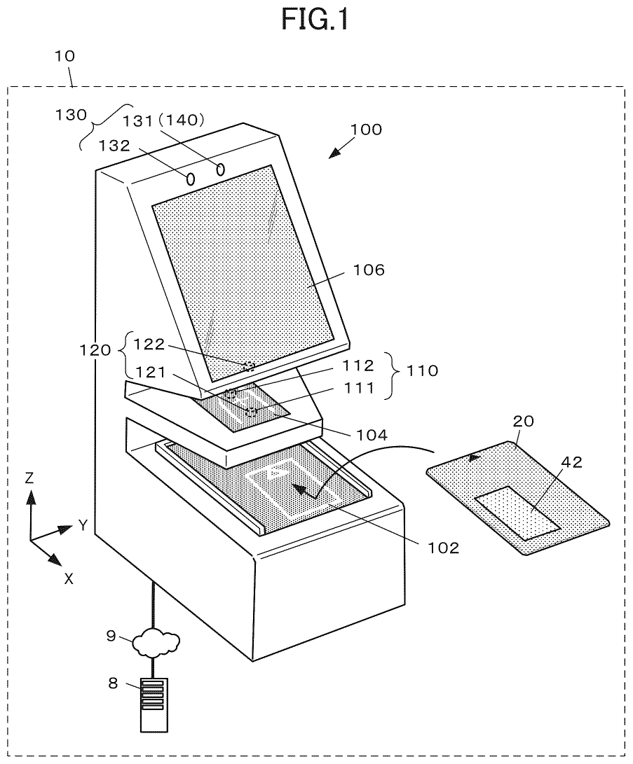

FIG. 1 is a diagram illustrating a configuration example of a card usage system 10. The card usage system 10 includes a card 20 that a user carries and uses, and a card usage apparatus 100 that is installed at the use site of the card 20.

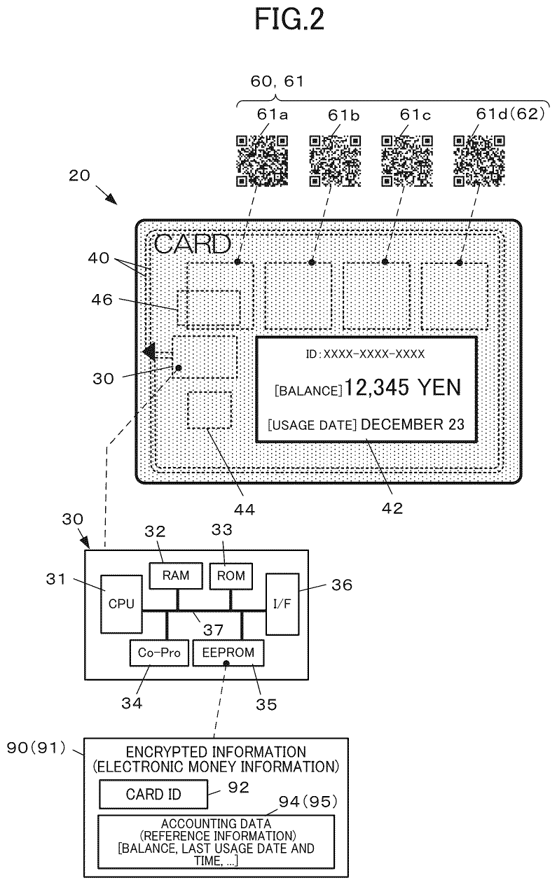

FIG. 2 is an external view of the card 20 as seen from the front side.

The card 20 is an electronic settlement card having a credit card size (for example, “ID-1” of the international standard “ISO/IEC 7810”: 53.98 mm long×85.60 mm wide×0.76 mm thick).

The card 20 is a card belonging to the category of contactless IC card, and includes an integrated circuit (IC) chip 30, an antenna coil 40, a display section 42, and a driver chip 44 that drives and controls the display section 42. The driver chip 44 may be integrated with the IC chip 30.

The IC chip 30 is configured by connecting a CPU 31, a RAM 32, a ROM 33, a coprocessor 34, an EEPROM 35, and an interface IC 36 via an internal bus 37, for example.

The coprocessor 34 is a processor specialized for biometric authentication for personal authentication and for arithmetic processing related to encryption/decryption of encrypted information 90 stored in the EEPROM 35.

The encrypted information 90 stored in the EEPROM 35 includes electronic money information 91. Specifically, the encrypted information 90 includes a unique card ID 92 and accounting data 94. The accounting data 94 includes at least the balance and the last usage date and time. The accounting data 94 includes data that serves as reference information 95 to which the user of the card 20 refers in using the card. The encrypted information 90 may also include other data as appropriate.

Depending on the amount of information to be stored, an expansion IC memory 46 may be incorporated, in addition to the IC chip 30, and used as an expansion storage area.

The interface IC 36 controls the input and output of signals to and from the outside. For example, the interface IC 36 is connected to a driver chip 44 and controls input and output of display control signals to and from the display section 42.

The display section 42 is a thin electronic paper display that can display characters and can maintain a state in which the reference information 95 is displayed without power consumption. Specifically, the display section 42 is implemented by an electrophoretic display device (EPD), a twisting ball display (TBD), an electrochromic display (ECD), or the like.

In the case of employing a method of displaying with supply of some power, the display section 42 may be another type of display device. For example, the display section 42 may be a liquid crystal display, an organic EL display, or the like. Depending on the information to be displayed, the display section 42 may be a device with a 7-segment display.

In using the card 20, identity verification is performed using biometric information. The card 20 has an invisible code section 60 that records biometric authentication data. The invisible code section 60 includes a plurality of biometric codes 61 (61a, 61b, . . . ). The number of biometric codes 61 can be set as appropriate.

The biometric codes 61 may be formed by printing with anti-counterfeit ink using an inkjet printing method, for example. The anti-counterfeit ink is an ink that is invisible under visible light but becomes visible when exposed to light in a specific wavelength range outside the visible light wavelength range, that is, transparent ink or invisible ink. Examples of the anti-counterfeit ink that can be used include short-wave ink that becomes visible when exposed to short-wave light, and long-wave ink that becomes visible when exposed to long-wave light.

In the example of FIG. 2, the biometric codes 61 are illustrated as matrix type two-dimensional codes. However, the code format, size, etc. are not limited to the example illustrated in FIG. 2 and can be set as appropriate. The code format, size, etc. of the biometric codes 61 may be set taking into consideration the amount of information to be included in the biometric codes 61, the number of biometric codes 61 to be included in the invisible code section 60, the area of the surface of the card 20, and the like.

One of the biometric codes 61 (the fourth biometric code 61d in the example of FIG. 2) is a normal code 62 generated by a predetermined code generation logic. The biometric codes 61 other than the normal code 62 are dummy. Which of the biometric codes 61 formed at the different positions is designated as the normal code 62 can be set as appropriate.

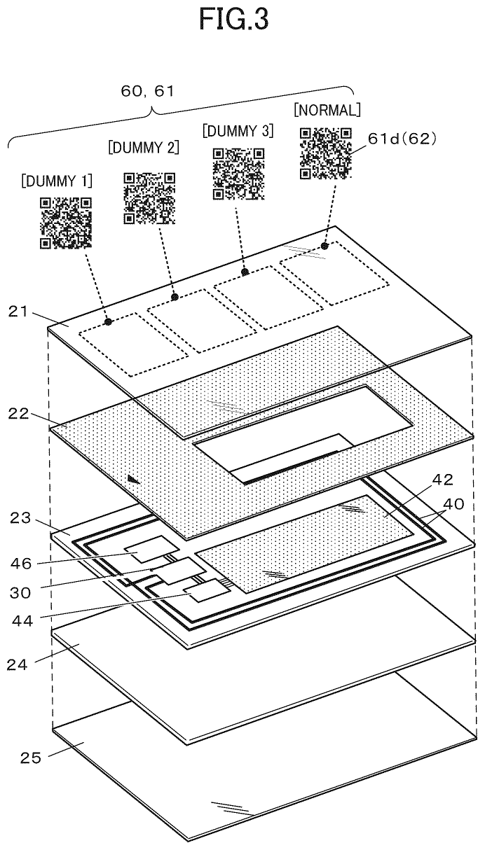

FIG. 3 is an exploded perspective view of an example structure of the card 20, as seen from obliquely above the front surface of the card.

The card 20 has a laminated structure. Starting from the front surface of the card, the card 20 has a front sheet layer 21, a front design layer 22, an IC layer 23, and a back sheet layer 25.

The front sheet layer 21 is formed as a coating layer by adhering a transparent (or translucent) sheet material or by applying or spraying a transparent (or translucent) resin. The invisible code section 60 is formed on the front sheet layer 21.

The front design layer 22 is a layer on which various characters, images, and color schemes that determine the design of the front side of the card 20 are provided. The front design layer 22 is made from a printed sheet material, or by printing onto a sheet material, for example.

The IC layer 23 is a layer including the IC chip 30, the antenna coil 40, the display section 42, and the driver chip 44. The IC layer 23 itself may be constituted of a laminate of a plurality of sub-layers.

The back sheet layer 25 is a layer on which various characters, images, and color schemes that determine the design of the back side of the card 20 are provided. The back sheet layer 25 is formed as a coating layer by adhering a transparent (or translucent) sheet material or by applying or spraying a transparent (or translucent) resin. The back sheet layer 25 may be omitted.

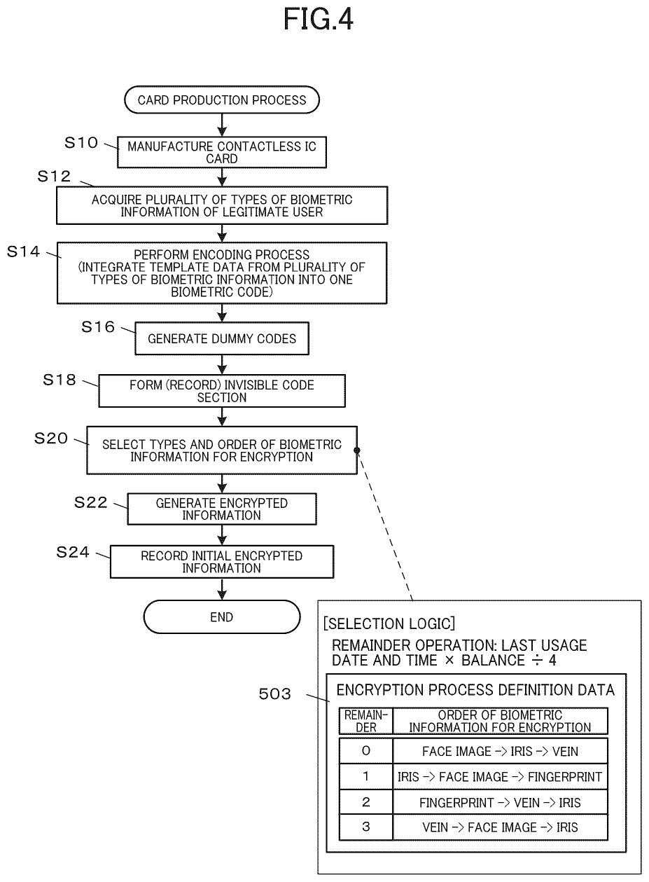

FIG. 4 is a flowchart illustrating a production process of the card 20.

First, a contactless IC card that will be the base for the card 20 is manufactured (step S10). If the base contactless IC card has already been produced and prepared, step S10 can be omitted.

Next, a plurality of types of biometric information on the legitimate user of the card are acquired (step S12). The four types of biometric information, iris, face, fingerprint, and finger vein, are used. The biometric information is acquired by a biometric information reading device that is prepared in advance at a store or the like that accepts applications for issuance of the card 20.

Next, an encoding process is performed (step S14). Specifically, the plurality of biometric codes 61 of the invisible code section 60 are generated. At least one of the plurality of biometric codes 61 is the normal code 62. In order to obtain the normal code 62, data for biometric authentication (reference data to be compared during authentication) is generated for each of the four types of biometric information acquired in step S12, and the four pieces of data are integrated into one piece of integrated data. The integrated data is then subjected to an encoding operation in accordance with a predetermined code standard to generate one code. Before encoding, the integrated data may be encrypted with a predetermined type of biometric information (for example, fingerprint, fingerprint+iris, or other information set as appropriate), and the encrypted integrated data may then be encoded.

Next, the remaining three dummy codes excluding the normal code 62 in the invisible code section 60 are generated (step S16). For example, an encoding operation may be performed on data in which part of the integrated data is missing or rewritten to generate dummy codes, or an encoding operation may be performed on data of only one of the four types of biometric information acquired in step S12 to generate dummy codes.

Next, the invisible code section 60 is formed on the contactless IC card manufactured in step S10 (step S18). That is, the biometric information of the user is encoded by a predetermined encoding process to generate the biometric codes 61, which are recorded in an invisible state.

Next, the types of biometric information to be used for encryption and the order in which to use the biometric information for encryption are selected using a predetermined selection logic (step S20).

The selection logic can be set as appropriate. An example of the selection logic is a remainder operation in which the number representing the last usage date and time is multiplied by the initial deposit amount and then divided by “4.” Note that “4” is merely an example, and “5” or “6” may be used instead.

The initial deposit amount is a predetermined amount to be paid at the time of application, for example. The method of describing the last usage date and time in the dividend of the remainder operation can be set as appropriate. For example, the last usage date and time may be described as an eight-digit integer consisting of a four-digit year, a two-digit month, and a two-digit date. Furthermore, the last usage date and time may be described as a 12-digit integer in which a two-digit hour and a two-digit minute are added to an eight-digit integer. The last usage date and time may be described as a four-digit integer consisting of a two-digit month and a two-digit date.

Then, encryption process definition data 503 is prepared in advance, in which the types and order of biometric information to be used are associated with the four types of remainders “0” to “3.” Then, the encryption process definition data 503 is referred to determine an encryption process consisting of the types of biometric information to be used for encryption and the order in which to use the biometric information for encryption. The encryption method using the biometric information can be set as appropriate. For example, a method may be used by which part or all of the biometric information is directly used as an encryption key.

Next, the types of biometric information and the order in which to use the biometric information for encryption selected in step S20 are applied to generate the encrypted information 90 (step S22). The generated encrypted information 90 is then stored in the new card 20 on which the invisible code section 60 was formed in step S18 (step S24). The card production process is completed.

Returning to FIG. 1, the card usage apparatus 100 communicates with an external settlement computer 8 via a network 9 and is used for electronic money settlement using the card 20. That is, from the viewpoint of the settlement computer 8, the card usage apparatus 100 can be said to be an extended terminal apparatus for electronic settlement.

The card usage apparatus 100 has a three-tier structure, with a card placement section 102 for the card 20 on the top surface of the first tier from the bottom, and a finger placement section 104 on the top surface of the second tier on which the user places his/her finger for fingerprint and vein reading.

The card usage apparatus 100 also has a fingerprint biometric information reading section 110 inside the lower part of the finger placement section 104, and a vein biometric information reading section 120 inside the upper part of the finger placement section 104.

The card usage apparatus 100 also has, on the third tier, a display 106 that faces the front side (X-axis direction of XYZ axes in FIG. 1), an iris biometric information reading section 130, and a face biometric information reading section 140.

The card usage apparatus 100 automatically detects that the card 20 has been placed on the card placement section 102, displays usage instructions on the display 106, and prompts the user for biometric authentication for identity verification. The card usage apparatus 100 reads biometric information using the fingerprint biometric information reading section 110, the vein biometric information reading section 120, the iris biometric information reading section 130, and the face biometric information reading section 140, and then performs biometric authentication to verify the identity of the user. If the authentication succeeds, the card usage apparatus 100 reads/writes the encrypted information 90 stored in the card 20.

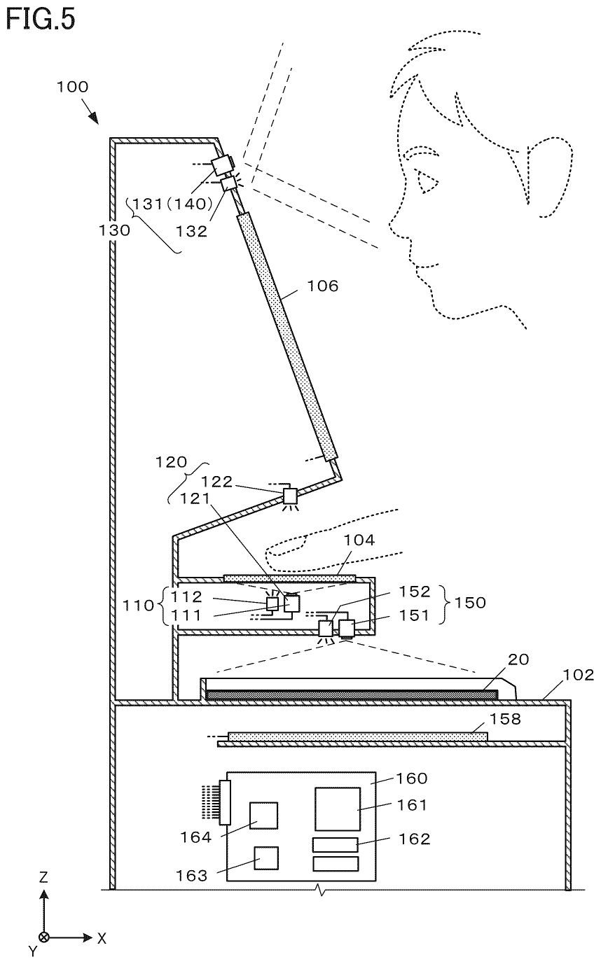

FIG. 5 is a schematic vertical cross-sectional view of a configuration example of the card usage apparatus 100.

The fingerprint biometric information reading section 110 includes a finger photographing camera 111 and a visible light source 112 that emits visible light. The finger photographing camera 111 is an imaging sensor (imaging element; for example, a CCD sensor or a CMOS sensor) that can simultaneously capture a color image in the visible light range and a near-infrared image in the near-infrared range. The fingerprint biometric information reading section 110 may include a processor that generates fingerprint image data.

The vein biometric information reading section 120 includes the finger photographing camera 111 (121) and a near-infrared light source 122 that emits near-infrared light. The vein biometric information reading section 120 may include a processor that generates vein image data.

The iris biometric information reading section 130 includes a face photographing camera 131 and a near-infrared light source 132. The face photographing camera 131 is an imaging element (for example, a CCD sensor or a CMOS sensor) that can simultaneously capture a color image in the visible light range and a near-infrared image in the near-infrared range. The iris biometric information reading section 130 may include a processor that generates iris image data.

The face biometric information reading section 140 is implemented by the face photographing camera 131. The face biometric information reading section 140 may include a processor that generates face image data.

The card usage apparatus 100 has a special reading section 150 above the card placement section 102.

The special reading section 150 has a color camera 151 that photographs the surface of the card 20 placed on the card placement section 102, and a special light source 152.

The color camera 151 is an imaging element (for example, a CCD sensor, a CMOS sensor, or the like) that can capture color images at least in the visible light range. The special light source 152 emits light in a specific wavelength range to visualize the anti-counterfeit ink used to form the biometric codes 61. The biometric code 61 exposed to light in the specific wavelength range can be photographed by the color camera 151.

The card usage apparatus 100 has an antenna section 158 for contactless IC cards and a controller board 160 inside the lower part of the card placement section 102 for the card 20.

The controller board 160 includes a CPU 161, an IC memory 162, a communication module 163, and an interface IC 164. The controller board 160 is connected via the interface IC 164 to the display 106, the fingerprint biometric information reading section 110, the vein biometric information reading section 120, the iris biometric information reading section 130, the face biometric information reading section 140, the special reading section 150, and the antenna section 158.

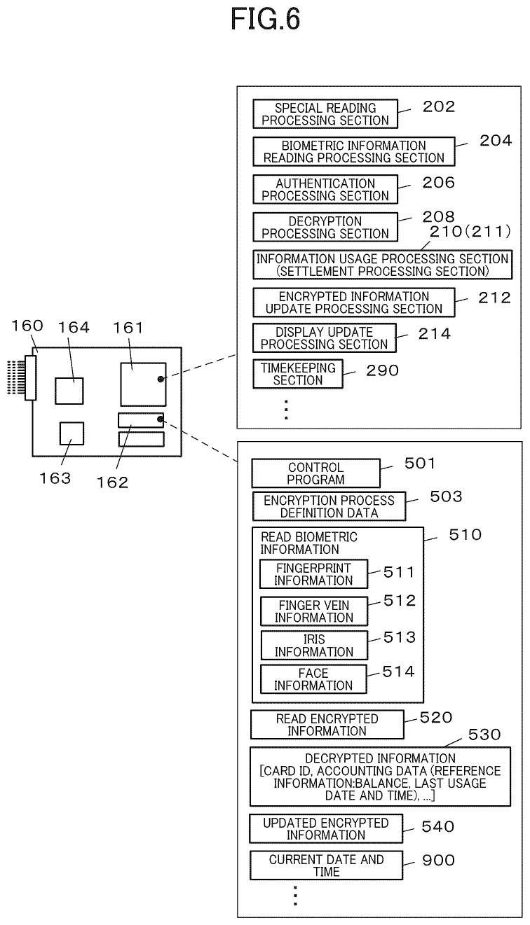

FIG. 6 is a diagram illustrating the functional sections mounted on the controller board 160, and programs, data, etc. stored in the IC memory 162. The IC memory 162 stores a control program 501, encryption process definition data 503, read biometric information 510, read encrypted information 520, decrypted information 530, updated encrypted information 540, and current date and time 900.

The control program 501 is read by the CPU 161 and processed, thereby causing the controller board 160 to perform the functions of a special reading processing section 202, a biometric information reading processing section 204, an authentication processing section 206, a decryption processing section 208, an information usage processing section 210, an encrypted information update processing section 212, a display update processing section 214, and a timekeeping section 290.

The special reading processing section 202 controls the special reading section 150 to execute a process of photographing and reading the biometric code 61 from the card 20.

The biometric information reading processing section 204 controls the fingerprint biometric information reading section 110, the vein biometric information reading section 120, the iris biometric information reading section 130, and the face biometric information reading section 140 to perform a process of reading biometric information from the user. For example, the biometric information reading processing section 204 may perform a process of generating a fingerprint image, a vein image, an iris image, and a face image from images captured by the individual biometric information reading sections, and perform a process of obtaining fingerprint feature information, vein feature information, iris feature information, and face feature information. If each biometric information reading section includes a processor for generating an image and a processor for calculating feature information, the biometric information reading processing section 204 does not need to execute the image generation process or the feature information calculation process.

The authentication processing section 206 performs an authentication process based on the biometric information read by the fingerprint biometric information reading section 110, the vein biometric information reading section 120, the iris biometric information reading section 130, and the face biometric information reading section 140, and the biometric code 61 read by the special reading section 150. The authentication processing section 206 may perform the process of obtaining the fingerprint feature information, the vein feature information, the iris feature information, and the face feature information.

If biometric authentication through the authentication process succeeds, the decryption processing section 208 decrypts the encrypted information 90 stored in the memory of the card 20 (for example, the EEPROM 35 or the expansion IC memory 46) using the biometric information read by the fingerprint biometric information reading section 110, the vein biometric information reading section 120, the iris biometric information reading section 130, and the face biometric information reading section 140.

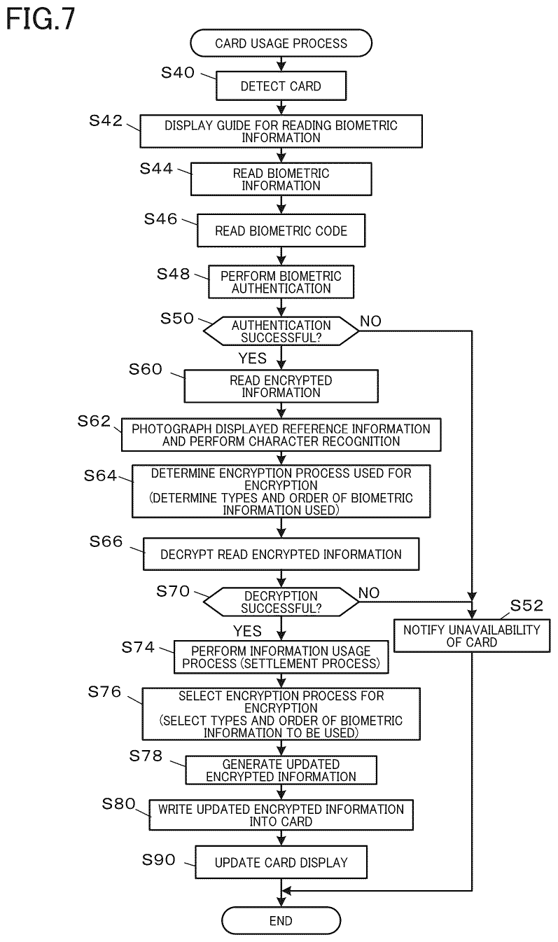

Specifically, the decryption processing section 208 photographs the display on the display section 42 of the card 20 with the color camera 151 and performs image recognition processing on the contents of reference information. Then, the decryption processing section 208 decrypts the encrypted information read from the card 20, using the type of biometric information selected according to the selection logic (as in step S90 in FIG. 7) based on the recognized reference information. That is, the decryption processing section 208 determines the biometric information that has been used for encryption and the order in which the biometric information has been used for encryption based on the selection logic, and decrypts the encrypted information three times using the same types of biometric information as used for encryption in the reverse order to that used for encryption.

If the decryption by the decryption processing section 208 succeeds, the information usage processing section 210 executes a predetermined information usage process based on the decrypted information. In the present embodiment, since the card 20 is an electronic settlement card, the information usage processing section 210 functions as a settlement processing section 211 that communicates with the settlement computer 8 (see FIG. 1) to execute a predetermined settlement process based on the decrypted information.

The encrypted information update processing section 212 encrypts the information updated in the information usage process using the read biometric information, and stores the encrypted information in the memory of the card 20 as new encrypted information. Specifically, the encrypted information update processing section 212 encrypts the information updated in the information usage process, using the type of biometric information selected according to the selection logic based on the information updated in the information usage process (including new reference information). Accordingly, new encrypted information (updated encrypted information 540) is generated. Then, the encrypted information update processing section 212 performs control to transmit a predetermined encrypted information update request signal and the new encrypted information to the card 20 via the antenna section 158. Upon receipt of the encrypted information update request signal and the new encrypted information, the card 20 updates the encrypted information 90.

The display update processing section 214 functions as a display update control section that performs a process of displaying new reference information based on the information updated in the information usage process, on the display section 42 of the card 20 (see FIG. 2). Specifically, the display update processing section 214 transmits a predetermined display update request signal to the card 20. Upon receipt of the display update request signal, the card 20 displays the reference information 95 (which has been updated in advance in response to the encrypted information update request from the encrypted information update processing section 212) stored in the memory (for example, the EEPROM 35 or the expansion IC memory 46).

The timekeeping section 290 manages the current date and time 900.

The read biometric information 510 includes four types of biometric information: fingerprint information 511, finger vein information 512, iris information 514, and face information 515.

The read encrypted information 520 is the result of reading the encrypted information 90 (see FIG. 2) stored in the card 20.

The decrypted information 530 is the result of decrypting the read encrypted information 520.

The updated encrypted information 540 is new information to be written to the card 20 and is updated data of the encrypted information 90.

FIG. 7 is a flowchart illustrating a flow of processing in the card usage apparatus 100.

When detecting the card 20 placed on the card placement section 102 (step S40), the card usage apparatus 100 displays a guide for reading biometric information on the display 106 (step S42). That is, the card usage apparatus 100 displays a message prompting the user to place the finger registered during card enrollment on the finger placement section 104 and to turn his/her face toward the display 106.

Next, the card usage apparatus 100 reads the biometric information of the user's fingerprint, finger veins, iris, and face using the fingerprint biometric information reading section 110, the vein biometric information reading section 120, the iris biometric information reading section 130, and the face biometric information reading section 140 (step S46).

Next, the card usage apparatus 100 reads the biometric codes 61 of the invisible code section 60 from the card 20 using the special reading section 150 (step S48). The invisible code section 60 has the plurality of biometric codes 61, one of which is the normal code 62. The card usage apparatus 100 selects the biometric code 61 at a predetermined position on the card 20 as the normal code 62. The card usage apparatus 100 then executes a biometric authentication process based on the read biometric information and the read normal code 62 (step S48).

If the authentication fails (NO in step S50), the card usage apparatus 100 displays a notice on the display 106 informing the user that the card cannot be used a (step S52), and ends the card usage process.

If the authentication succeeds (YES in step S50), the card usage apparatus 100 reads the encrypted information 90 stored in the card 20 (step S60). The read information is temporarily stored as the read encrypted information 520 (see FIG. 6).

Next, the card usage apparatus 100 photographs the characters displayed on the display section 42 of the card 20 with the color camera 151, performs character recognition processing, and acquires the contents of the displayed reference information 95 (step S62).

Next, the card usage apparatus 100 determines the encryption process using a predetermined selection logic (step S64). That is, as in step S90 (see FIG. 4), the card usage apparatus 100 performs a remainder operation based on the reference information 95 acquired in step S62 to obtain the remainder. Then, the card usage apparatus 100 refers to the encryption process definition data 503 to determine the types of biometric information that has been used for generating the encrypted information 90 stored in the card 20 and the order in which the biometric information has been used.

The card usage apparatus 100 then decrypts the read encrypted information 520 by reversing the encryption process determined in step S64 (step S70).

If the decryption fails (NO in step S70), the card usage apparatus 100 notifies the user that the card cannot be used (step S52), and ends the card usage process.

If the decryption succeeds (YES in step S70), the decryption result is temporarily stored as the decrypted information 530 (see FIG. 6). The card usage apparatus 100 communicates with the settlement computer 8 (see FIG. 1) and executes an information usage process, that is, a settlement process (step S74). In the settlement process, the balance in the decrypted information 530 is updated by subtracting the amount used, and the last usage date and time is changed to the current date and time 900.

Next, as in step S90 (see FIG. 4), the card usage apparatus 100 determines the encryption process according to the selection logic, and selects the types of biometric information to be used and the order in which to use the biometric information (step S76).

Next, the card usage apparatus 100 applies the selected types of biometric information and order in which to use the biometric information to encrypt the decrypted information 530 updated in step S74 to generate the updated encrypted information 540 (step S78; see FIG. 6). Then, the card usage apparatus 100 writes the updated encrypted information 540 into the memory of the card 20 (step S80). Accordingly, the encrypted information 90 and reference information 95 stored in the memory of the card 20 are updated.

Next, the card usage apparatus 100 transmits a predetermined request signal to the card 20 to update the display on the display section 42 (step S90), and ends the series of steps.

As described above, according to the present embodiment, it is possible to provide a technology for improving the security of information recording cards. That is, biometric authentication data (biometric information) for verifying the identity of the user is encoded and recorded on the card in an invisible manner. Therefore, it is possible to easily verify the identity of the user when using the card, while cleverly concealing biometric information, thereby improving the security of the card.

Additionally, the card 20 has the invisible code section 60 provided on the sheet layer. Therefore, for example, it is possible to prepare an unused card with a front sheet layer 21 before card issuance, and then issue the card 20 by additionally forming the invisible code section 60 on the front sheet layer 21 at the time of card issuance. Without the biometric information of the legitimate user who owns the card 20, authentication by the biometric code 61 of the invisible code section 60 cannot be obtained, and the encrypted information cannot be decrypted. This further improves the security of the card.

Furthermore, since the biometric code 61 is recorded in an invisible state, it is difficult to know that the biometric code 61 exists. Therefore, the security of the card 20 is further improved as compared to conventional cases.

### MODIFICATION EXAMPLES

Although examples of embodiments to which the present disclosure is applied have been described above, the embodiments to which the present disclosure can be applied are not limited to the above embodiments, and components can be added, omitted, or modified as appropriate.

### Modification Example 1

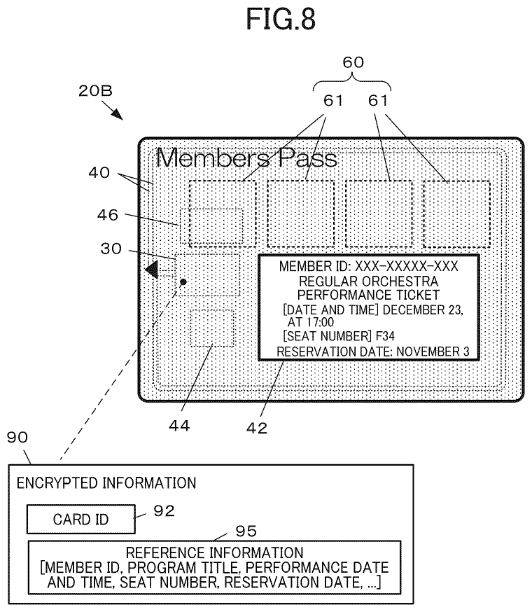

In the above embodiments, the card 20 is exemplified as an electronic settlement card, but it may be used for other purposes. For example, a card 20B illustrated in FIG. 8 is used as a membership card of a fan club of a certain orchestra and also as an electronic ticket to performance. In this case, reference information 95 of encrypted information 90 includes the member ID, program title, performance date and time, seat number, reservation date, and the like.

Another use of the card 20 may be an entrance/exit management card given to a facility user. In this case, the reference information 95 of the encrypted information 90 may be the user ID, affiliation, entry and exit dates and times, and the like.

### Modification Example 2

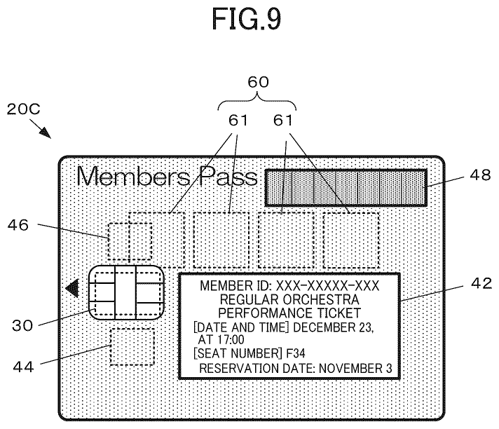

In the above embodiments, the card 20 is exemplified as a contactless IC card, but it may be a contact IC card like a card 20C in FIG. 9. A display section 42 is not limited to electronic paper, and may be implemented by an LCD or the like. In this case, a solar panel 48 may be provided to supply power to the display section 42. When the user takes out the card 20C in a well-lit place, reference information 95 is displayed on the display section 42.

### Modification Example 3

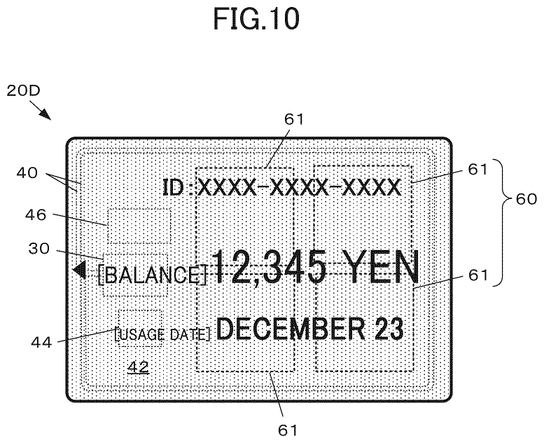

As in a card 20D illustrated in FIG. 10, the size of a display section 42 may cover the entire surface or substantially the entire surface of the card. In this case, the design on the front surface of the card is presented as a display image on the display section 42. An invisible code section 60 may be formed so as to overlap the display section 42 not only on the card 20D but also on the cards 20, 20B, and 20C.

### Modification Example 4

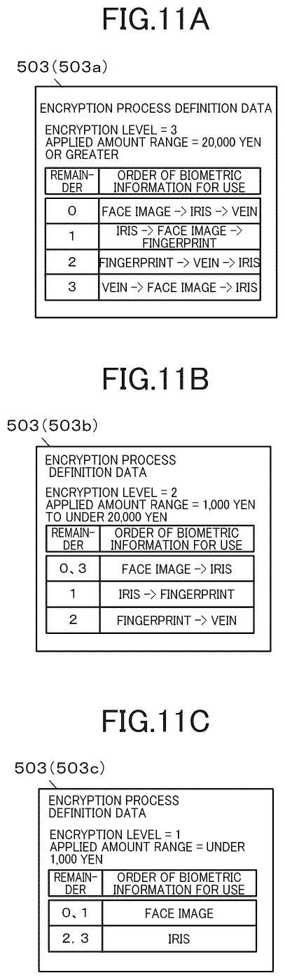

In the above embodiments, the encryption process definition data 503 defines a plurality of encryption processes, but the number of pieces of biometric information used is the same among the encryption processes. That is, the level of encryption is the same. However, the encryption level may be varied based on reference information 95. For example, as illustrated in FIGS. 11A, 11B, and 11C, a plurality of pieces of encryption process definition data 503 (503a, 503b, and 503c) with different encryption levels are prepared for each applied amount range for the balance in the reference information 95. Then, in step S76 (see FIG. 7), a card usage apparatus 100 may select and refer to the encryption process definition data 503 that matches the balance in the reference information 95 to select an encryption process.

In the plurality of pieces of encryption process definition data 503 (503a, 503b, and 503c), the encryption level may be set to a lower level as the balance amount is smaller, for example. As the encryption level is lower, the types of biometric information to be used and the number of processes (the number of times encryption is performed) may be decreased. The number of encryption levels can be set as appropriate.

### Modification Example 5

A card 20 may be configured such that a protective coating layer is further added to the surface of a front sheet layer 21 on which an invisible code section 60 is formed. The invisible code section 60 may be formed on a back sheet layer 25 instead of the front sheet layer 21.

### [Recapitulation]

The contents disclosed in this specification can be summarized as follows.

### First Aspect

A card carried and used by a user, including:
an invisible code section in which a biometric code obtained by encoding biometric information of the user through a predetermined encoding process is recorded in an invisible state;
a memory configured to store encrypted information encrypted using the biometric information; and
a display section configured to display reference information that is referenced by the user when using the card.

### Second Aspect

The card according to the first aspect, further including a transparent or translucent sheet layer provided on the display section, wherein the invisible code section is provided on the sheet layer.

### Third Aspect

The card according to the first or second aspect, wherein
the biometric code recorded in the invisible code section is fixedly recorded in a state that is capable of being photographed by a predetermined camera, and
the encrypted information is information that is encrypted in a manner capable of being decrypted based on the biometric code photographed by the camera.

### Fourth Aspect

The card according to any one of the first to third aspects, wherein
the encrypted information is information that is used upon use of the card by the user, and
the display section updates and displays the reference information, which is to be updated in accordance with use of the encrypted information, every time the encrypted information is used.

### Fifth Aspect

The card according to the fourth aspect, wherein
the encrypted information is information relating to electronic money, and
the memory stores information obtained by decrypting and using the encrypted information based on the biometric code, and encrypting the information after use based on the biometric code, as the new encrypted information.

### Sixth Aspect

The card according to the fifth aspect, wherein the reference information includes at least information indicating a balance of the electronic money.

### Seventh Aspect

The card according to any one of the first to sixth aspects, wherein the display section is electronic paper.

### Eighth Aspect

A card usage apparatus including:
a special reading section configured to photograph and read the biometric code from the card according to any one of the first to seventh aspects;
a biometric information reading section configured to read biometric information from the user;
an authentication processing section configured to perform an authentication process based on the biometric information read by the biometric information reading section and the biometric code read by the special reading section;
a decryption processing section configured to, if authentication by the authentication process succeeds, decrypt the encrypted information stored in the memory using the biometric information read by the biometric information reading section;
an information usage processing section configured to, if decryption by the decryption processing section succeeds, execute a predetermined information usage process based on the decrypted information; and
an encrypted information update processing section configured to encrypt the information updated in the information usage process using the biometric information read by the biometric information reading section and store the encrypted information in the memory as the new encrypted information.

### Ninth Aspect

A card usage apparatus including:
a special reading section configured to photograph and read the biometric code from the card according to the fifth or sixth aspect;
a biometric information reading section configured to read biometric information from the user;
an authentication processing section configured to perform an authentication process based on the biometric information read by the biometric information reading section and the biometric code read by the special reading section;
a decryption processing section configured to, if authentication by the authentication process succeeds, decrypt the encrypted information stored in the memory using the biometric information read by the biometric information reading section;
a settlement processing section configured to, if decryption by the decryption processing section succeeds, execute a predetermined settlement process based on the decrypted information;
an encrypted information update processing section configured to generate the new encrypted information by encrypting the information updated in the settlement process using the biometric information read by the biometric information reading section, and store the new encrypted information in the memory; and
a display update control section configured to cause the new reference information based on the information updated in the settlement process to be displayed on the display section.

### Tenth Aspect

The card usage apparatus according to the ninth aspect, wherein
the biometric information includes a plurality of types of biometric information,
the encrypted information is encrypted with a type of biometric information selected in accordance with a predetermined selection logic based on the reference information,
the decryption processing section decrypts the encrypted information stored in the memory using the type of biometric information selected in accordance with the selection logic based on the reference information before the settlement process, and
the encrypted information update processing section generates the new encrypted information by encrypting the information updated in the settlement process using the type of biometric information selected in accordance with the selection logic based on the new reference information.

Although only some embodiments of the present invention have been described in detail above, those skilled in the art will readily appreciate that many modifications are possible in the embodiments without materially departing from the novel teachings and advantages of this invention. Accordingly, all such modifications are intended to be included within scope of this invention.

1. A card carried and used by a user, comprising:
an invisible code section in which a biometric code obtained by encoding biometric information of the user through a predetermined encoding process is recorded in an invisible state;
a memory configured to store encrypted information encrypted using the biometric information; and
a display section configured to display reference information that is referenced by the user when using the card.

2. The card as defined in claim 1, further comprising a transparent or translucent sheet layer provided on the display section, wherein the invisible code section is provided on the sheet layer.

3. The card as defined in claim 1, wherein
the biometric code recorded in the invisible code section is fixedly recorded in a state that is capable of being photographed by a predetermined camera, and
the encrypted information is information that is encrypted in a manner capable of being decrypted based on the biometric code photographed by the camera.

4. The card as defined in claim 1, wherein
the encrypted information is information that is used upon use of the card by the user, and
the display section updates and displays the reference information, which is to be updated in accordance with use of the encrypted information, every time the encrypted information is used.

5. The card as defined in claim 3, wherein
the encrypted information is information that is used upon use of the card by the user, and
the display section updates and displays the reference information, which is to be updated in accordance with use of the encrypted information, every time the encrypted information is used.

6. The card as defined in claim 4, wherein
the encrypted information is information relating to electronic money, and
the memory stores information obtained by decrypting and using the encrypted information based on the biometric code, and encrypting the information after use based on the biometric code, as the new encrypted information.

7. The card as defined in claim 5, wherein
the encrypted information is information relating to electronic money, and
the memory stores information obtained by decrypting and using the encrypted information based on the biometric code, and encrypting the information after use based on the biometric code, as the new encrypted information.

8. The card as defined in claim 6, wherein the reference information includes at least information indicating a balance of the electronic money.

9. The card as defined in claim 7, wherein the reference information includes at least information indicating a balance of the electronic money.

10. The card as defined in claim 1, wherein the display section is electronic paper.

11. A card usage apparatus comprising:
a special reading section configured to photograph and read the biometric code from the card as defined in claim 1;
a biometric information reading section configured to read biometric information from the user;
an authentication processing section configured to perform an authentication process based on the biometric information read by the biometric information reading section and the biometric code read by the special reading section;
a decryption processing section configured to, if authentication by the authentication process succeeds, decrypt the encrypted information stored in the memory using the biometric information read by the biometric information reading section;
an information usage processing section configured to, if decryption by the decryption processing section succeeds, execute a predetermined information usage process based on the decrypted information; and
an encrypted information update processing section configured to encrypt the information updated in the information usage process using the biometric information read by the biometric information reading section and store the encrypted information in the memory as the new encrypted information.

12. A card usage apparatus comprising:
a special reading section configured to photograph and read the biometric code from the card as defined in claim 6;
a biometric information reading section configured to read biometric information from the user;
an authentication processing section configured to perform an authentication process based on the biometric information read by the biometric information reading section and the biometric code read by the special reading section;
a decryption processing section configured to, if authentication by the authentication process succeeds, decrypt the encrypted information stored in the memory using the biometric information read by the biometric information reading section;
a settlement processing section configured to, if decryption by the decryption processing section succeeds, execute a predetermined settlement process based on the decrypted information;
an encrypted information update processing section configured to generate the new encrypted information by encrypting the information updated in the settlement process using the biometric information read by the biometric information reading section, and store the new encrypted information in the memory; and
a display update control section configured to cause the new reference information based on the information updated in the settlement process to be displayed on the display section.

13. The card usage apparatus as defined in claim 12, wherein
the biometric information includes a plurality of types of biometric information,
the encrypted information is encrypted with a type of biometric information selected in accordance with a predetermined selection logic based on the reference information,
the decryption processing section decrypts the encrypted information stored in the memory using the type of biometric information selected in accordance with the selection logic based on the reference information before the settlement process, and
the encrypted information update processing section generates the new encrypted information by encrypting the information updated in the settlement process using the type of biometric information selected in accordance with the selection logic based on the new reference information.
